(19) United States
(12) Patent Application Publication
(10) Pub. No.: US 2004/0083270 A1
(43) Pub. Date: Apr. 29, 2004

(54) Method and system for identifying junk e-mail

(76) Inventors: David Heckerman, Bellevue, WA (US); Kirsten Fox, Seattle, WA (US); Jordan Luther King Schwartz, Seattle, WA (US); Bryan Starbuck, Duvall, WA (US); Gail Borod, Seattle, WA (US); Robert Rounthwaite, Fall City, CA (US); Eric Horvitz, Kirkland, WA (US)

Correspondence Address: SHOOK, HARDY & BACON LLP, 2555 GRAND BLVD, KANSAS CITY,, MO, 64108, US

(21) Appl. No.: 10/278,591

(22) Filed: Oct. 23, 2002

(51) Int. Cl. G06F 15/16

(52) U.S. Cl. 709/207

(57) ABSTRACT

The present invention is directed to a method and system for use in a computing environment to customize a filter utilized in classifying mail messages for a recipient. The present invention enables a recipient to reclassify a message that was previously classified by the filter, where the reclassification reflects the recipient's perspective of the class to which the message belongs. The reclassified messages are collectively stored in a training store. The information in the training store is then used to train the filter for future classifications, thus customizing the filter for the particular recipient. Further, the present invention is directed to adapting a filter to facilitate better detection and classification of spam over time by continuously retraining the filter. The retraining of the filter is an iterative process that utilizes previous spam fingerprints and message samples, to develop new spam fingerprints that are then utilized for the filtering process.

### CROSS-REFERENCE TO RELATED APPLICATIONS

None.

### TECHNICAL FIELD

The present invention relates to computer software. More particularly, the invention is to directed to a system and method for identifying junk e-mail through a junk mail filter that has been personalized for a user. The present invention collects data relating to mail messages and trains a filter to better identify and classify spam over time.

### BACKGROUND OF THE INVENTION

Electronic messaging, particularly electronic mail (“e-mail”) over the Internet, has became quite pervasive in society. Its informality, ease of use and low cost make it a preferred method of communication for many individuals and organizations.

Unfortunately, as has occurred with more traditional forms of communication, such as a postal mail and telephone, e-mail recipients are being subjected to unsolicited mass mailings. With the explosion, particularly in the last few years, of Internet-based commerce, a wide and growing variety of electronic merchandisers are repeatedly sending unsolicited mail advertising their products and services to an ever-expanding universe of e-mail recipients. Most consumers who order products or otherwise transact with a merchant over the Internet expect to and, in fact, do regularly receive such solicitations from those merchants. However, electronic mailers are continually expanding their distribution lists to penetrate deeper into society in order to reach more people. In that regard, recipients who merely provide their e-mail addresses in response to requests for visitor information generated by various web sites, often later find that they have been included on electronic distribution lists. This occurs without the knowledge, let alone the assent, of the recipients. Moreover, as with postal direct-mail lists, an electronic mailer will often disseminate its distribution list, whether by sale, lease or otherwise, to another such mailer for its use, and so forth with subsequent mailers. Consequently, over time, e-mail recipients often find themselves increasingly barraged by unsolicited mail resulting from separate distribution lists maintained by a wide variety of mass mailers. Though certain avenues exist through which an individual can request that their name be removed from most direct mail postal lists, no such mechanism exists among electronic mailers.

Once a recipient finds themselves on an electronic mailing list, that individual can not readily, if at all, remove their address from it. This effectively guarantees that (s)he will continue to receive unsolicited mail. This unsolicited mail usually increases over time. The sender can effectively block recipient requests or attempts to eliminate this unsolicited mail. For example, the sender can prevent a recipient of a message from identifying the sender of that message (such as by sending mail through a proxy server). This precludes that recipient from contacting the sender in an attempt to be excluded from a distribution list. Alternatively, the sender can ignore any request previously received from the recipient to be so excluded.

An individual can easily receive hundreds of pieces of unsolicited postal mail in less than a year. By contrast, given the extreme ease and insignificant cost through which c-distribution lists can be readily exchanged and e-mail messages disseminated across extremely large numbers of addresses, a single e-mail addressee included on several distribution lists can expect to receive a considerably large number of unsolicited messages over a much shorter period of time.

Furthermore, while many unsolicited e-mail messages are benign, such as offers for discount office or computer supplies or invitations to attend conferences of one type or another; others, such as pornographic, inflammatory and abusive material, are highly offensive to their recipients. All such unsolicited messages, whether e-mail or postal mail, collectively constitute so-called “junk” mail. To easily differentiate between the two, junk e-mail is commonly known, and will alternatively be referred to herein, as “spam”.

Similar to the task of handling junk postal mail, an e-mail recipient must sift through his/her incoming mail to remove the spam. Unfortunately, the choice of whether a given e-mail message is spam or not is highly dependent on the particular recipient and the actual content of the message. What may be spam to one recipient, may not be so to another. Frequently, an electronic mailer will prepare a message such that its true content is not apparent from its subject line and can only be discerned from reading the body of the message. Hence, the recipient often has the unenviable task of reading through each and every message (s)he receives on any given day, rather than just scanning its subject line, to fully remove all the spam. Needless to say, this can be a laborious, time-consuming task. At the moment, there appears to be no practical alternative.

In an effort to automate the task of detecting abusive newsgroup messages (so-called “flames”), the art teaches an approach of classifying newsgroup messages through a rule-based text classifier. Given handcrafted classifications of each of these messages as being a “flame” or not, the generator delineates specific textual features that, if present or not in a message, can predict whether, as a rule, the message is a flame or not. These existing detection systems suffer from a number of disadvantages.

First, existing spam detection systems require the user to manually construct appropriate rules to distinguish between legitimate mail and spam. Given the task of doing so, most recipients will not bother to do it. As noted above, an assessment of whether a particular e-mail message is spam or not can be rather subjective with its recipient. What is spam to one recipient may not be, for another. Furthermore, non-spam mail varies significantly from person to person. Therefore, for a rule based-classifier to exhibit acceptable performance in filtering out most spam from an incoming stream of mail addressed to a given recipient, that recipient must construct and program a set of classification rules that accurately distinguishes between what to him/her constitutes spam and what constitutes non-spam (legitimate) e-mail. Properly doing so can be an extremely complex, tedious and time-consuming manual task even for a highly experienced and knowledgeable computer user.

Second, the characteristics of spam and non-spam e-mail may change significantly over time; rule-based classifiers are static (unless the user is constantly willing to make changes to the rules). In that regard, mass e-mail senders routinely modify the content of their messages in an continual attempt to prevent recipients from initially recognizing these messages as spam and then discarding those messages without fully reading them. Thus, unless a recipient is willing to continually construct new rules or update existing rules to track changes in the spam, then, over time, a rule-based classifier becomes increasingly inaccurate at distinguishing spam from desired (non-spam) e-mail. This diminishes its utility and frustrates its user. A technique is needed that adapts itself to track changes over time, in both spam and non-spam content, and subjective user perception of spam. Furthermore, this technique should be relatively simple to use, if not substantially transparent to the user, and eliminate any need for the user to manually construct or update any classification rules or features.

When viewed in a broad sense, use of such a needed technique could likely and advantageously empower the user to individually filter his/her incoming messages, by their content, as (s)he saw fit. The filtering adapts over time to salient changes in both the content itself and in subjective user preferences of that content.

In light of the foregoing, there exists a need to provide a system and method that will enable the identification and classification of spam versus desired e-mail. More importantly, such identification would be customized for individual recipients as determined by the iteratively trained custom filter. Furthermore, there exists a need for a method of easily initiating the training and refraining of a spam filter, to further facilitate the ability of the filter to change and adapt to changed spam formats.

### SUMMARY OF THE INVENTION

The present invention is directed to a method and system for use in a computing environment to customize a filter utilized in classifying mail messages for a recipient.

In one aspect, the present invention is directed to enabling a recipient to reclassify a message that was classified by the filter, where the reclassification reflects the recipient's perspective of the class to which the message belongs. A training store is then populated with samples of messages that are reflective of the recipients classification.

The information in the training store is then used to train the filter for future classifications, thus customizing the filter for the particular recipient.

In another aspect, the present invention is directed to adapting a filter to facilitate better detection and classification of spam over time by continuously retraining the filter. The retraining of the filter is an iterative process that utilizes previous spam fingerprints and message samples, to develop new spam fingerprints that are then utilized for the filtering process.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means, instrumentalities and combinations particularly pointed out in the appended claims.

### BRIEF DESCRIPTION OF THE SEVERAL VIEWS OF THE DRAWING

The present invention is described in detail below with reference to the attached drawings figures, wherein:

FIG. 1 is a block diagram of a computing system environment suitable for use in implementing the present invention;

FIG. 2 is a block diagram illustration of components that are suitable to practice the present invention;

FIG. 2B is a flow diagram of the classification process of the present invention;

FIG. 3 is a flow diagram illustrating the interaction between monitoring and training within the system of the present invention;

FIG. 4 is a table of user actions and the cues that such actions provide with regards to the classification of a message;

FIG. 5A is a block diagram illustrating the location and connection of a filter for a group of clients; and

FIG. 5B is a block diagram illustrating the location of a filter for individual clients.

### DETAILED DESCRIPTION OF THE INVENTION

The present invention is directed to enabling the creation of a personalized junk mail filter for a user. The present invention automatically and manually classifies incoming mail as junk or non-junk and then uses those messages to train a probabilistic classifier of junk mail otherwise referred to herein as a filter. The training and classification process is iterative, with the newly trained filter classifying mail to train the next generation filter, thus creating an adaptive filter that can efficiently react to and accommodate changes in the structure and content of junk mail over time. According to the present invention, there is junk detection performed on incoming mail, resulting in a sorted data collection of mail. These sorted data collections serve as a source of training samples, which are ultimately used to retrain a filter. In particular, the filter becomes trained for a specific end user. In other words, from one user system to another the filter is radically different, making it tougher for spamers to anticipate a workaround. Through the present invention a filter is able to learn new words and to generate new weighting for classifying messages, all of which are utilized in the filtering process. The present invention enables a filter to follow spam over time and also enables a better success rate because it can be specific to individual users.

By obtaining patterns from message content rather than message signatures or message headers, the filter is able to counteract a spamer's ability to circumvent traditional filters. The present invention can be implemented on a server or on individual clients. The invention can be readily incorporated into stand-alone computer programs or systems, or into multifunctional mail server systems. Nonetheless, to simplify the following discussion and facilitate understanding, the discussion will be presented in the context of use by a recipient within a client e-mail system that executes on a personal computer, to detect spam.

After considering the following description, those skilled in the art will clearly realize that the teachings of the present invention can be utilized in substantially any e-mail or electronic messaging application to detect messages that a given user is likely to consider “junk”.

Though spam is becoming pervasive and problematic for many recipients, oftentimes what constitutes spam is subjective with its recipient. Other categories of unsolicited content, which are rather benign in nature such as office equipment promotions or invitations to conferences, will rarely, if ever, offend anyone and may be of interest to and not regarded as spam by a fairly decent number of its recipients. However, even these messages could be considered spam when directed to the wrong individual.

Conventionally speaking, given the subjective nature of spam, the task of determining whether, for a given recipient, a message situated in an incoming mail folder is spam or not falls squarely on its recipient. The recipient must read the message, or at least enough of it, to make a decision as to how (s)he perceives the content in the message and then discard the message as spam, or not. Knowing this, mass e-mail senders routinely modify their messages over time in order to thwart most of their recipients from quickly classifying these messages as spam, particularly from just their abbreviated display as provided by conventional client e-mail programs. As such and at the moment, e-mail recipients effectively have no control over what incoming messages appear in their incoming mail folder, particularly because their filtering systems are static or require extensive effort by the recipient. The present invention provides training for filters, where that training is customized to the recipients preferences without requiring an inordinate amount of work.

Having briefly described an embodiment of the present invention, an exemplary operating environment for the present invention is described below.

Exemplary Operating Environment

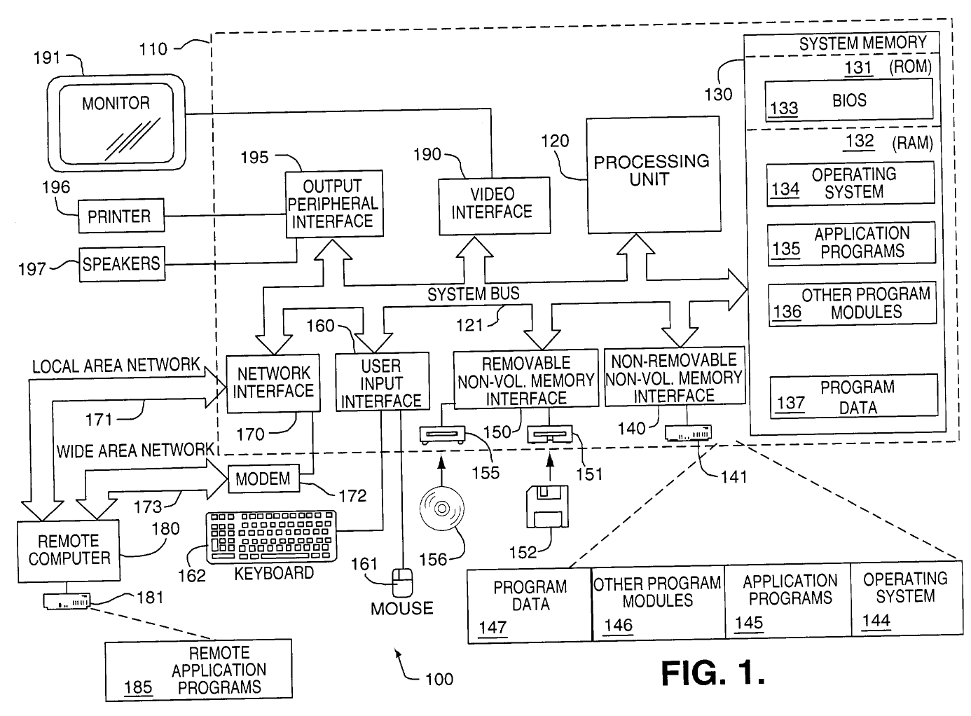

FIG. 1 is a block diagram of a computing system environment suitable for use in implementing the present invention;

Referring to the drawings in general and initially to FIG. 1 in particular, wherein like reference numerals identify like components in the various figures, an exemplary operating environment for implementing the present invention is shown and designated generally as operating environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with a variety of computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system 100 for implementing the invention includes a general purpose computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. Examples of computer storage media include, but are not limited to, RAM, ROM, electronically erasable programmable read-only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during startup, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Typically, the operating system, application programs and the like that are stored in RAM are portions of the corresponding systems, programs, or data read from hard disk drive 141, the portions varying in size and scope depending on the functions desired. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

When the computer 110 is turned on or reset, the BIOS 133, which is stored in the ROM 131 instructs the processing unit 120 to load the operating system, or necessary portion thereof, from the hard disk drive 140 into the RAM 132. Once the copied portion of the operating system, designated as operating system 144, is loaded in RAM 132, the processing unit 120 executes the operating system code and causes the visual elements associated with the user interface of the operating system 134 to be displayed on the monitor 191. Typically, when an application program 145 is opened by a user, the program code and relevant data are read from the hard disk drive 141 and the necessary portions are copied into RAM 132, the copied portion represented herein by reference numeral 135.

System and Method for Identifying Junk E-Mail

Advantageously, the present invention permits an incoming mail message to be filtered and sorted into one of two buckets i.e. junk and valid mail, based on the content of the message. Through a process that involves some minimal user interaction, the present invention enables an end user to further train and customize a filter to more appropriately and accurately classify each incoming e-mail message to suit the recipient's preferences.

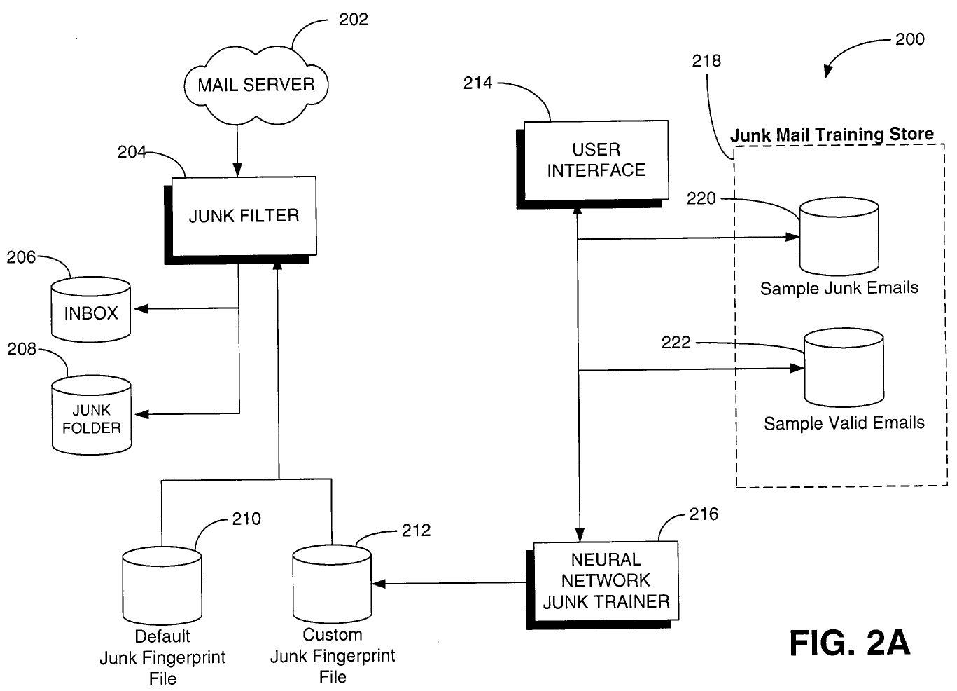

The present invention will be discussed with reference to an implementation for a single user and a computer based electronic mail system such as Microsoft Network (MSN) mail. Components that are utilized to provide filtering, training and data collection in the present invention are illustrated in FIG. 2A and are generally referenced as 200. In general and as shown, a Mail Server 202 such as HOTMAIL Server, is the source for e-mail messages. Each message is downloaded and then passed through a junk Filter 204 wherein a process occurs to separate the mail into an Inbox 206 or a Junk Folder 208. As used herein, an Inbox 206 is a repository for e-mail that is deemed to be valid, i.e. non-spam. The Junk Folder 208 is a repository for e-mail that is unsolicited and a nuisance to the user, i.e. spam. This separation or classification of mail is accomplished through the use of a fingerprint file.

A fingerprint file is a collection of rules and patterns that can be utilized by various algorithms to aide in the identification or classification of one or more items within a mail message. The identification or classification being further used to determine whether or not the item(s) within the message are indicative of the message being spam. In essence, a fingerprint file can be thought of as a set of predefined features including words, special multiword phrases and key terms that are found in e-mail messages. A fingerprint file may also include formatting attributes that can be compared against spam signature formats. In other words, because spams tend to have certain characteristics or ‘signatures’, a cross reference of the content of a message to a collection of signatures can identify the message as spam or not. The present invention utilizes any one of or a combination of a Default Junk Fingerprint File 210 and a Custom Junk Fingerprint File 212. One of the features of the present invention is the creation and updating of the Custom Junk Fingerprint File 212, which will be discussed in further detail below.

A User Interface 214 is provided to enable a recipient to confirm or disagree with the classification of mail by the Filter 204. Information relating to the recipient's decision is utilized and processed by a Neural Network Junk Trainer 216, which then populates a Training Store 218, with Sample Junk E-mails 220 and Sample Valid E-mails 222. The flow chart of FIG. 2B in conjunction with the diagram of FIG. 2A will be used to more fully discuss the interaction between recipient actions and the training samples of the present invention.

Each incoming e-mail message in a message stream is first downloaded from Mail Server 202 at step 224. The incoming e-mail is passed through Filter 204 at step 226 to analyze and detect features that are particularly characteristic of spam. This task is accomplished by utilizing the one or more fingerprint files 210, 212. The Filter 204 results in a decision being made regarding whether or not an e-mail message is spam or not, as shown at step 228. In the event that the e-mail message is determined to be spam, the message is placed in the Junk Folder 208, at step 230. Alternatively, if the message is valid the message is placed in the Inbox Folder 206, at step 232.

The classification process also enables recipient interaction with the classified or sorted messages through the User Interface 214, at step 234. The recipient is able to decide if individual mail messages have been placed in the appropriate folders. In one embodiment, a recipient is able to select individual messages within the Inbox Folder 206 and Junk Folder 208, and identify the message as spam or valid mail by utilizing an on-screen toggle selection. This decision making process is illustrated at step 236. Essentially, if the user agrees with the classification made by the Filter 204, the message remains in the folder where it was placed. Conversely, if the user disagrees with the classification process, the message is forwarded to the Neural Network Junk Trainer 216 for further processing, at step 238. The message is then stored as an appropriate sample in the Training Store 218, at step 240. The Training Store 218 contains samples of spam and valid mail, which are separately stored in Sample Junk Mail Folder 220 and Sample Valid Mail Folder 222 respectively. In other words, the recipient can move information that has been erroneously missed or misclassified to an appropriate folder. More importantly, such correction by the recipient serves to further teach or train the system to prevent future misclassifications and yield more personalized and accurate sorting of spam and valid e-mail.

To this end, the present invention further includes a training scheme, which is a method for continuous and iterative customization of a spam filter. When a Filter 204 is first shipped or delivered to a customer there is preferably a Default Junk Fingerprint File 210. During the initial use of the Filter 204 the Default Fingerprint File 210 is utilized by the Filter 204 for classifying and placing messages in the Inbox 206 or Junk Folder 208. Over time, the present invention collects sufficient information and sample messages as previously described, that can then be used to develop more customized recipient preferences. These preferences can be used to further personalize the Filter 204 and better detect spam for the recipient. These preferences or customized fingerprints are collectively stored in Custom Junk Fingerprint File 212.

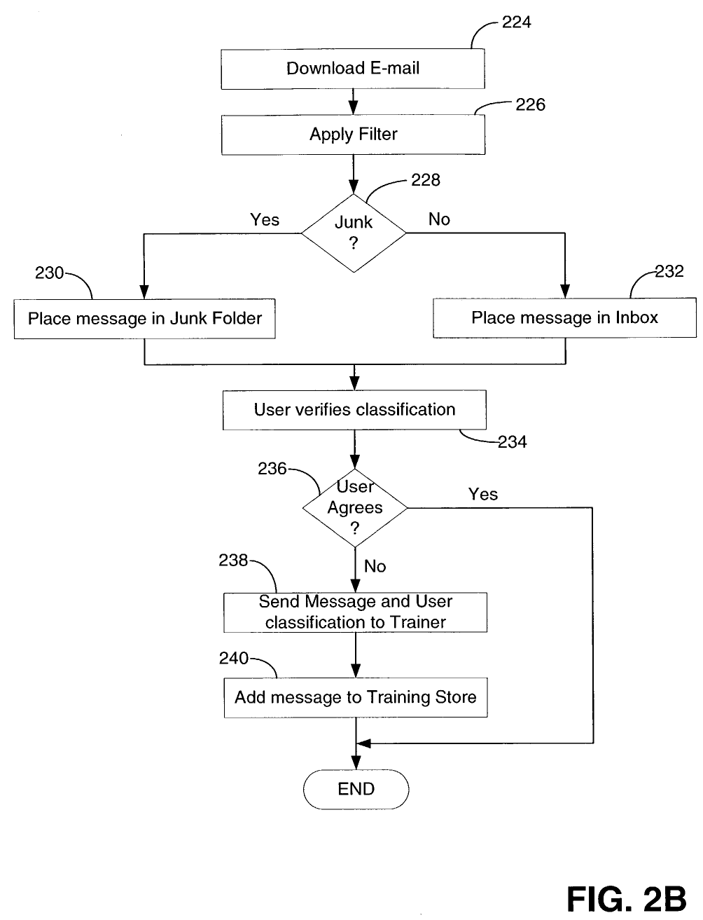

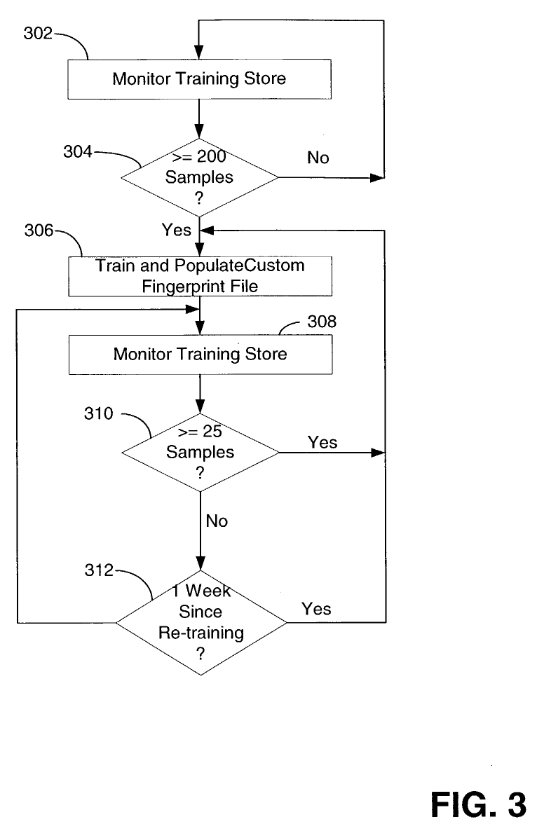

In general the presence of a certain number of samples or the occurrence of certain cues, initiate a training process. These training triggers along with the required cues for retraining will be discussed with reference to FIG. 3 and FIG. 4.

Conceptually, the training function of the Filter 204 is implemented to further perfect the classification and improve the user experience. Recipient selections, actions on messages and message reclassification provide the information base for training the system. The Filter 204 is custom trained and becomes more tailored to individual recipients in an incremental and iterative process.

Turning initially to FIG. 3, a flow diagram illustrates the process of populating the Custom Fingerprint File 212. As filtering of mail messages occurs a component of the present invention monitors the number of messages in Junk Mail Training Store 218, at step 302. As previously discussed, Junk Mail Training Store 218 contains Sample Junk E-mails 220 and Sample Valid E-mails 222. When mail messages are added to each of these stores, a monitoring component tracks the number of sample messages within each store. At step 304, a determination is made as to whether there are at least a threshold number of samples in each of the sample stores. For example, a threshold value of 400 samples could be the trigger. In the event that there are not at least 400 samples, the monitoring process merely resumes. Once the minimal threshold of 400 samples has been reached an initial training process by the Neural Network Junk Trainer 216 commences, at step 306. The training of the Filter 204 entails a process that is described in an application for Letters Patent, Ser. No. 09/102,837, which is hereby incorporated. The result of this training process is the population of the Custom Junk Fingerprint File 212.

Following the initial training, the continuous monitoring of the Junk Mail Training Store 218 resumes at step 308. Subsequent training of the Filter 204 commences after there are at least 25 samples within each of the training stores. In other words, if the Junk E-mail Store 220 and the Valid E-mail Store 222 each have 25 samples or more, a retraining of the system will ensue. Here again, 25 is an arbitrary number. Alternatively, if a time threshold has passed since the last retraining, the system will also initiate a retraining. For example, if one week has passed since the last retraining, the system will initiate a retraining. These two alternatives are depicted at step 310 and step 312 consecutively. In effect, because training is ongoing and because training continues to refine and populate the Custom Junk Fingerprint File 212, which is utilized to obtain the training samples, the entire process is iterative. The information obtained from prior training is not discarded but is also incorporated into the filtering process. Either the Custom Junk Fingerprint File 212 alone is utilized or both Fingerprint Files 210, 212 are utilized for filtering incoming mail.

As previously discussed, recipient interaction in the form of User Interface 214 enables a user to correct classification errors and facilitate the populating of the Junk Mail Training Store 218 and more specifically the Sample Junk E-mails 220 and Sample Valid E-mails 222. However, in some cases the recipient may not always correct the filter errors or specifically classify messages. It is therefore possible that the filter may become inappropriately biased over time. A further embodiment of the present invention addresses this situation by spontaneously prompting the collection of sample e-mails based on certain cues that are triggered by a recipient's actions. An exemplary list of such action cues is presented in the table of FIG. 4.

As shown in FIG. 4, there are a series of recipient actions, other than the tagging of a message as junk, or not junk, which cause the system to add a message to the Sample Junk E-mails 220 or the Sample Valid E-mails 222. In other words, a given action by a recipient with respect to a particular received message may cause that message to be added to the Training Store 218 for junk e-mails or valid e-mails. In practice, there are essentially three groupings of cues namely, Don't Train Group 402, Not Junk Group 404 and Junk Group 406. As the group names suggest, a cue from a particular group would result in no training of the Filter 204, such as for Don't Train Group 402 or the addition of a message to the Sample Valid E-mails 222 or Sample Junk E-mails 220 such as for each of Not Junk Group 404 and Junk Group 406. For example, an action by a user, such as deleting an unread message from the inbox, will essentially be ignored by the system since this is a Do Not Train Cue 402. As mentioned above, there are certain actions that are indicative of the fact that a particular message is not junk. Such actions include moving a message out of the junk folder, moving a message into any other folder, replying to a message that is not in the junk folder, replying to a message that is in the junk folder and opening a message without moving or deleting the message. These recipient actions or cues are listed in the Not Junk Group 404. All of these actions indicate some interest by the user that allows an assumption that the mail is not junk. Actions indicative that a message belongs to the junk folder as Junk Cues 406 include such things as deleting an item in the junk folder, moving an item into the junk folder, or emptying the junk folder. All of these actions indicate a lack of interest by the user that allows an assumption that the mail is junk. Upon the occurrence of any of the Non-Junk Cues 404 or Junk Cues 406 the system will populate the Sample Junk E-mail 220 or Sample Valid E-mail 222 stores as appropriate.

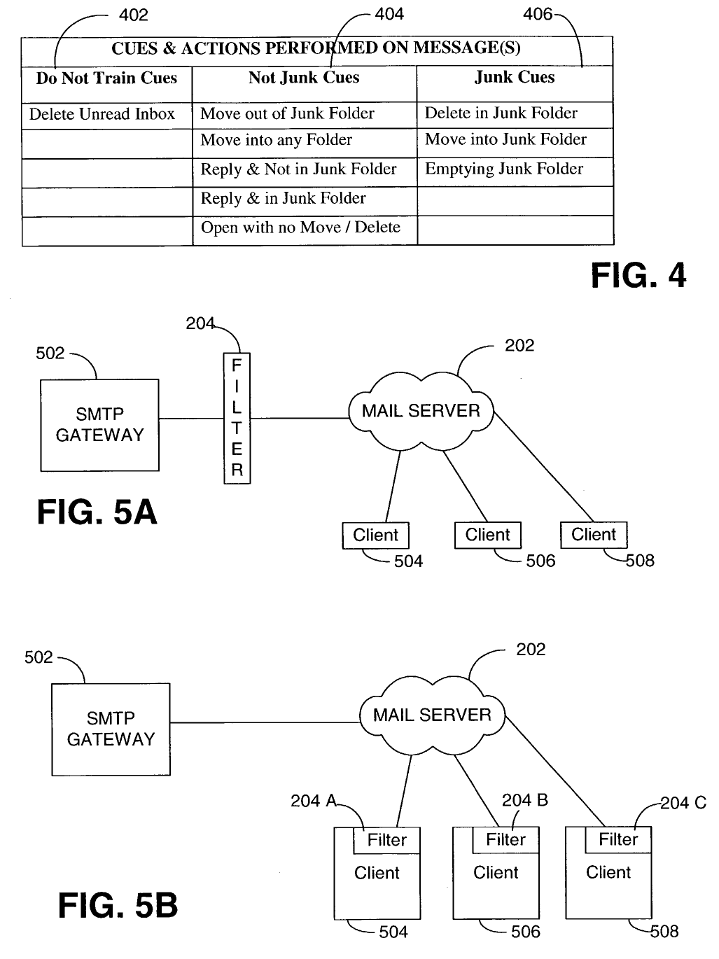

As previously mentioned, the filter of the present invention can be located on individual client systems or on a server to serve multiple users. FIGS. 5A and 5B illustrate exemplary installations of the filter. As shown in FIG. 5A a Filter 204 can be located between an SMTP Gateway 502 and a Mail Server 202. The Mail Server 202 has a number of Clients 504, 506 and 508 connected to it. In this configuration, all of the features previously discussed with respect to the customization of the filter would still be applicable. Furthermore, customization would be tailored to the preferences of the recipients as a group. For example, assume that an organization has multiple mail servers. The associated filter for each mail server will be unique with respect to the other mail servers, by virtue of the fact that each mail server hosts different users who will most likely define spam differently. The Filter 204 would thus be customized to the selections and signatures of each of Clients 504, 506 and 508 collectively. Cues and retraining will occur based on the collective actions of each of the Clients 504, 506 and 508.

In an alternate configuration, Filter 204 could be installed on each of the Clients 504, 506 and 508 individually as shown in FIG. 5B. The individual Client Filters 204A, 204B and 204C essentially function as described earlier within this specification and are individually unique. It should be noted that there are advantages to either of the configurations illustrated in FIG. 5A or FIG. 5B. For example, the Group Filter 204 of FIG. 5A enables a corporation or organization to have filters that are based on collective input from all of their users. An organization could then pool the information from each of the custom junk fingerprint files to provide a uniform definition for spam throughout the organization. On the other hand, the illustrative configuration of FIG. 5B provides more user specific filtering and consequently a morphic filter that more easily adapts to changes in spam as defined by the individual user.

To the extent that a filter does not generalize, and that the filter is user specific, it becomes more difficult for spamers to get around the filter since spams are generally geared towards more generalized filtering mechanisms. In other words, a spamer would have a much more difficult time overcoming or adapting to a specific user's valid message pattern. It would be more difficult for spamers to morph their messages to look more like an individual customer's message because each customer's valid message signature is different. Thus the associated customer's unique filter is more likely to be effective in detecting spam as defined by that customer.

The method of the present invention follows spam over time, further resulting in better success rates. Even further, the method of obtaining valid message patterns from message content rather than headings, along with the utilization of recipient action and interaction cues and the iterative training and retraining process, provide numerous advantages and benefits over existing filtering systems.

As would be understood by those skilled in the art, the functions discussed herein can be performed on a client side, a server side or any combination of both. These functions could also be performed on any one or more computing devices, in a variety of combinations and configurations, and such variations are contemplated and within the scope of the present invention.

The present invention has been described in relation to particular embodiments which are intended in all respects to be illustrative rather than restrictive. Alternative embodiments will become apparent to those skilled in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated and within the scope of the claims.

We claim:

1. A computer implemented method for customizing a filter utilized in classifying mail messages for a recipient, comprising:
enabling a recipient to reclassify a message that was classified by the filter, the reclassification reflecting the recipient's perspective of the class to which said message belongs;
populating a training store of sample messages with said message that was reclassified;
training the filter using the contents of said training store; and
classifying future messages with the filter to provide classification that is consistent with the recipient's reclassification.

2. A method as recited in claim 1, wherein training comprises:
monitoring and comparing the number of messages within said training store to a preset threshold level; and
providing the contents of said training store to a trainer component for training the filter when said preset threshold level has been reached.

3. A method as recited in claim 2, wherein said preset threshold level is initially set to 400 messages.

4. A method as recited in claim 2, wherein training further comprises:
providing information to identify and characterize message types within said training store, as one or more fingerprints; and
storing said one or more fingerprints for later use by the filter for classification.

5. A method as recited in claim 1, wherein said training store contains a sample spam folder.

6. A method as recited in claim 1, wherein said training store contains a sample valid folder.

7. A computer readable medium having computer executable instructions for customizing a filter utilized in classifying mail messages for a recipient, the method comprising:
enabling a recipient to reclassify a message that was classified by the filter, the reclassification reflecting the recipient's perspective of the class to which said message belongs;
populating a training store of sample messages with said message that was reclassified; and
training the filter using the contents of said training store, to cause the filter to classify future messages in a manner that is more consistent with the recipient's reclassification.

8. A computer system having a processor, a memory and an operating environment, the computer system operable to execute a method for customizing a filter utilized to classifying mail messages sent to a recipient, the method comprising:
enabling a recipient to reclassify a message that was classified by the filter, the reclassification reflecting the recipient's perspective of the class to which said message belongs;
populating a training store of sample messages with said message that was reclassified; and
training the filter using the contents of said training store, to cause the filter to classify future messages in a manner that is more consistent with the recipient's reclassification.

9. A method for classifying an incoming message, comprising:
receiving the incoming message;
utilizing a filter that can be trained and customized, to adaptively identify and classify the incoming message; and
assigning the incoming message to one or more folders according to the classification by said filter;
said filter being trained and retrained on the basis of one or more actions performed by one or more intended recipients of the incoming message;
said filter operating on the body and content of the incoming message to identify the class for the incoming message.

10. A method as recited in claim 9, wherein said one or more actions is a specific selection of a class for said incoming message, by said one or more intended recipients.

11. A method as recited in claim 9, wherein said one or more actions is a cue.

12. A method as recited in claim 9, wherein said incoming message is an electronic mail message and said class is a non-legitimate (spam) message.

13. A method as recited in claim 11, wherein said cue results from said one or more intended recipients moving said incoming message from one folder to another.

14. A method as recited in claim 11, wherein said cue results from said one or more intended recipients replying to said incoming message.

15. A method in a computing system for adapting a message filter, to facilitate better detection and classification of spam over time, comprising:
storing messages that have been classified by the filter and re-classified by a recipient as sample messages; and
retraining the message filter after a threshold number of sample messages have been collected or after a threshold time period has elapsed, to obtain fingerprints of spam;
wherein retraining comprises:
utilizing a first spam fingerprint and a plurality of previously collected message samples, to develop a second spam fingerprint; and
detecting and classifying incoming messages by utilizing said second spam fingerpint to filter incoming messages to a recipient.

16. A computer readable medium having computer executable instructions for identifying a class of an incoming messages, the method comprising:
receiving the incoming message;
utilizing a filter that can be trained and customized to adaptively identify and classify the incoming message; and
assigning the incoming message to one or more folders according to the classification by said filter;
said filter being trained and retrained on the basis of one or more actions performed by one or more intended recipients of the incoming message;
said filter operating on the body and content of incoming message to identify the class for the incoming message.
